(19) United States
(12) Patent Application Publication
(10) Pub. No.: US 2014/0133582 A1
(43) Pub. Date: May 15, 2014

(54) ENHANCING DIGITAL SIGNALS

(71) Applicant: RTC Vision Ltd., Kibbutz Givat Hashlosha (IL)

(72) Inventors: Nir Avrahami, Herzliya (IL); Jacob (Slava) Chernoi, Tel Aviv (IL)

(73) Assignee: RTC Vision Ltd., Kibbutz Givat Hashlosha (IL)

(21) Appl. No.: 14/077,670

(22) Filed: Nov. 12, 2013

Related U.S. Application Data
(60) Provisional application No. 61/725,197, filed on Nov. 12, 2012.

(51) Int. Cl. H04B 1/10; H04N 7/26

(52) U.S. Cl. CPC H04B 1/10; H04N 19/00903
USPC 375/240.26; 375/346

(57) ABSTRACT

Systems and methods are disclosed for enhancing digital signals. In one implementation, a digital signal that has undergone a non-linear distortion can be received. The non-linear distortion can be reformulated as one or more linear operators that yield a statistical connection between a first signal and a second signal and one or more convex constraints on the first signal and/or the second signal. A convex minimization problem can be formulated in view of the first signal, the second signal, and the one or more convex constraints. The digital signal can be processed to solve the convex minimization problem, thereby generating an enhanced digital signal.

### CROSS-REFERENCE TO RELATED APPLICATION

This application is related to and claims the benefit of U.S. Patent Application No. 61/725,197, filed Nov. 12, 2012, the entirety of which is incorporated herein by reference.

### TECHNICAL FIELD

Aspects and implementations of the present disclosure relate to data processing, and more specifically, to enhancing digital signals.

### BACKGROUND

Limitations due to low quality signals, such as digital signals, are present in a large range of applications. Settings in which such limitations are present include: TV broadcast, MP3 audio, smart phone and computer displays, video games, live concerts, forensics, various audio and/or video related applications, resampling and more.

Nowadays, due to the rapid increase in the size of digital data, and the need for fast and reliable streaming of content, almost all digital data is compressed. The compression process aims at removing redundancy in digital signals. While this can be done without losing any information, the attained compression rates are typically quite low. As such, most digital signals today are compressed using lossy-compression methods (JPEG, MPEG, MP3 etc.).

In addition to compression, most digital data is degraded even before it is compressed, simply due to the various imperfections of the acquiring devices, for example optical blur in video due to the imperfection of the lens.

It is with respect to these and other considerations that the disclosure made herein is presented.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, a digital signal that has undergone a non-linear distortion can be received. The non-linear distortion can be reformulated as one or more linear operators that yield a statistical connection between a first signal and a second signal and one or more convex constraints on the first signal and/or the second signal. A convex minimization problem can be formulated in view of the first signal, the second signal, and the one or more convex constraints. The digital signal can be processed to solve the convex minimization problem, thereby generating an enhanced digital signal.

These and other aspects, features, and advantages can be appreciated from the accompanying description and the accompanying drawing figures and claims.

### BRIEF DESCRIPTION OF THE DRAWINGS

FIG. 1 is a high-level diagram illustrating an exemplary configuration of a signal enhancement system, in accordance with one implementation of the present disclosure.

FIG. 2 depicts a flow diagram of aspects of a method for enhancing digital signals, in accordance with one implementation of the present disclosure.

FIG. 3 depicts a schematic diagram of various aspects of the present disclosure.

FIG. 4 depicts a flow diagram of aspects of a method for enhancing digital signals, in accordance with one implementation of the present disclosure.

FIG. 5 depicts a schematic diagram of various aspects of the present disclosure.

FIG. 6 depicts a schematic diagram of various aspects of the present disclosure.

### DETAILED DESCRIPTION

Described herein are systems and methods for enhancement of one or more low quality (LQ) digital signals, such as signals that have undergone one or more non-linear distortions. Such LQ signals can be acquired in a variety of methods, such as via a digital recording device (e.g., a video camera or a sound recording device), by scanning/sampling other signals, and/or by compressing an existing digital signal.

In various digital signal enhancement problems, a solution is achieved by assuming a linear distortion model, and solving the subsequent linear equations. However, in some enhancement problems, such as when lossy compression is introduced, assuming such a linear model yields insufficient results. Solving non-linear equations can be numerically cumbersome or even impossible. As such, in almost all relevant cases, a high quality (HQ) signal cannot be reconstructed from the LQ data with absolute accuracy. Different methods offer better results in some applications, and poorer results in other. Not only the quality of the resulting HQ signal separates various methods, but also practical measures, such as run-time, required hardware (CPU, GPU, memory, etc.) ease of use and more.

Accordingly, described herein are systems and methods that provide techniques/approaches for improved digital signal enhancement. In certain of the described techniques, the referenced non-linearity can be modeled, such as by introducing an intermediate slack variable between the linear and non-linear part of the acquisition model. The transition between the new slack variable and the result of the non-linear operator can then be linearized. Additionally, the modeling error can be considered as a constraint for the referenced algorithm.

The efficiency of the techniques/algorithms described herein can be appreciated, for example, in relation to problem pertaining to generating a super-resolution (SR) image(s) from compressed video. In general, such algorithms can be applied to a single signal or multiple signals (such as signals that describe the same HQ source-signal). The disclosed technologies are applicable and can be advantageously implemented in a multitude of applications, such as deblurring, denoising, speech recognition, audio enhancement, up-sampling, removing compression artifacts, super resolution, optical character recognition (OCR), face recognition and more (and any combination thereof).

The technologies described herein include systems and methods for enhancing digital signals. The referenced systems and methods are now described more fully with reference to the accompanying drawings, in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms, as appreciated by one skilled in the art. Therefore, it is to be understood that any structural and functional details disclosed herein are not to be interpreted as limiting the systems and methods, but rather are provided as a representative embodiment and/or arrangement for teaching one skilled in the art one or more ways to implement the systems and methods. Accordingly, aspects of the present systems and methods can take the form of an entirely hardware embodiment, an entirely software embodiment (including firmware, resident software, micro-code, etc.), or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer. Furthermore, the terms and phrases used herein are not intended to be limiting, but rather are to provide an understandable description of the systems and methods.

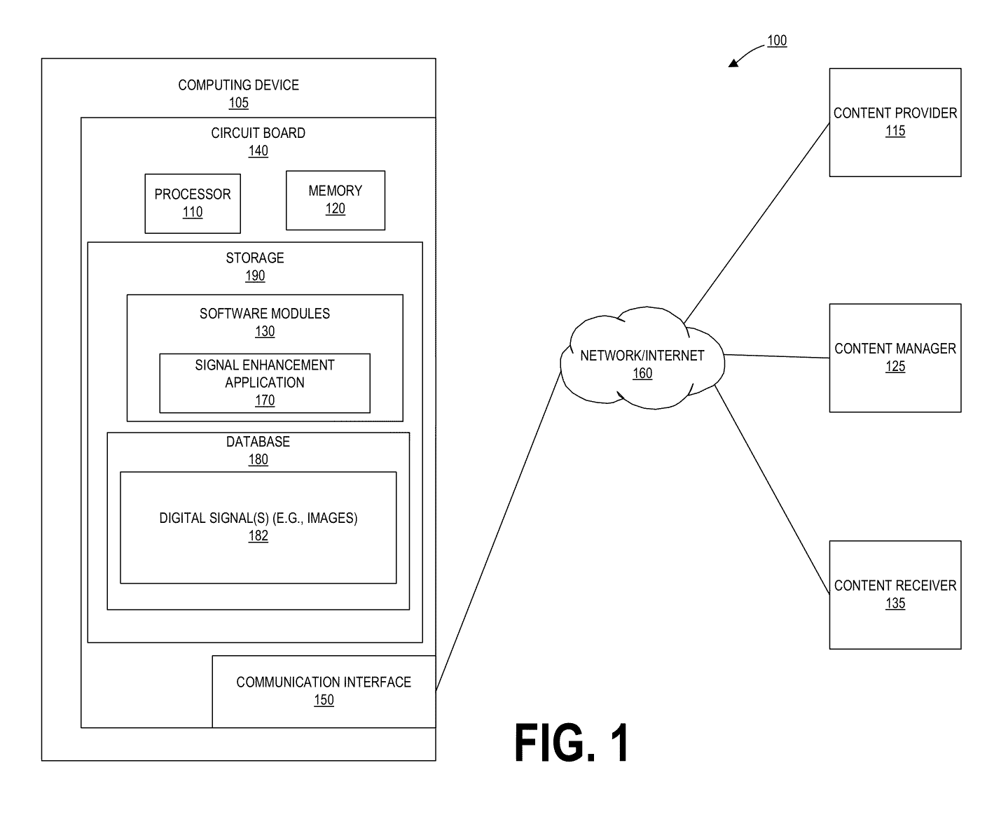

An exemplary computer system is shown as a block diagram in FIG. 1 which is a high-level diagram illustrating an exemplary configuration of a signal enhancement system 100. In one implementation, computing device 105 can be a personal computer or server. In other implementations, computing device 105 can be a tablet computer, a laptop computer, or a mobile device/smartphone, though it should be understood that computing device 105 of signal enhancement system 100 can be practically any computing device and/or data processing apparatus capable of embodying the systems and/or methods described herein.

Computing device 105 of signal enhancement system 100 includes a circuit board 140, such as a motherboard, which is operatively connected to various hardware and software components that serve to enable operation of the signal enhancement system 100. The circuit board 140 is operatively connected to a processor 110 and a memory 120. Processor 110 serves to execute instructions for software that can be loaded into memory 120. Processor 110 can be a number of processors, a multi-processor core, or some other type of processor, depending on the particular implementation. Further, processor 110 can be implemented using a number of heterogeneous processor systems in which a main processor is present with secondary processors on a single chip. As another illustrative example, processor 110 can be a symmetric multi-processor system containing multiple processors of the same type.

In certain implementations, memory 120 and/or storage 190 are accessible by processor 110, thereby enabling processor 110 to receive and execute instructions stored on memory 120 and/or on storage 190. Memory 120 can be, for example, a random access memory (RAM) or any other suitable volatile or non-volatile computer readable storage medium. In addition, memory 120 can be fixed or removable. Storage 190 can take various forms, depending on the particular implementation. For example, storage 190 can contain one or more components or devices such as a hard drive, a flash memory, a rewritable optical disk, a rewritable magnetic tape, or some combination of the above. Storage 190 also can be fixed or removable.

One or more software modules 130 are encoded in storage 190 and/or in memory 120. The software modules 130 can comprise one or more software programs or applications having computer program code or a set of instructions executed in processor 110. Such computer program code or instructions for carrying out operations for aspects of the systems and methods disclosed herein can be written in any combination of one or more programming languages, including an object oriented programming language such as Java, Smalltalk, C++, Python, and JavaScript or the like and conventional procedural programming languages, such as the “C” programming language or similar programming languages. The program code can execute entirely on computing device 105, partly on computing device 105, as a stand-alone software package, partly on computing device 105 and partly on a remote computer/device, or entirely on the remote computer/device or server. In the latter scenario, the remote computer can be connected to computing device 105 through any type of network, including a local area network (LAN) or a wide area network (WAN), or the connection can be made to an external computer (for example, through the Internet 160 using an Internet Service Provider).

One or more software modules 130, including program code/instructions, are located in a functional form on one or more computer readable storage devices (such as memory 120 and/or storage 190) that can be selectively removable. The software modules 130 can be loaded onto or transferred to computing device 105 for execution by processor 110. It can also be said that the program code of software modules 130 and one or more computer readable storage devices (such as memory 120 and/or storage 190) form a computer program product that can be manufactured and/or distributed in accordance with the present disclosure, as is known to those of ordinary skill in the art.

It should be understood that in some illustrative embodiments, one or more of software modules 130 can be downloaded over a network to storage 190 from another device or system via communication interface 150 for use within signal enhancement system 100. For instance, program code stored in a computer readable storage device in a server can be downloaded over a network from the server to signal enhancement system 100.

In certain implementations, included among the software modules 130 is a signal enhancement application 170 that is executed by processor 110. During execution of the software modules 130, and specifically the signal enhancement application 170, the processor 110 configures the circuit board 140 to perform various operations relating to signal enhancement with computing device 105, as will be described in greater detail below. It should be understood that while software modules 130 and/or signal enhancement application 170 can be embodied in any number of computer executable formats, in certain implementations software modules 130 and/or signal enhancement application 170 comprise one or more applications that are configured to be executed at computing device 105 in conjunction with one or more applications or ‘apps’ executing at remote devices, such as computing device(s) 115, 125, and/or 135 and/or one or more viewers such as internet browsers and/or proprietary applications. Furthermore, in certain implementations, software modules 130 and/or signal enhancement application 170 can be configured to execute at the request or selection of a user of one of computing devices 115, 125, and/or 135 (or any other such user having the ability to execute a program in relation to computing device 105, such as a network administrator), while in other implementations computing device 105 can be configured to automatically execute software modules 130 and/or signal enhancement application 170, without requiring an affirmative request to execute. It should also be noted that while FIG. 1 depicts memory 120 oriented on circuit board 140, in an alternate arrangement, memory 120 can be operatively connected to the circuit board 140. In addition, it should be noted that other information and/or data relevant to the operation of the present systems and methods (such as database 180) can also be stored on storage 190, as will be discussed in greater detail below.

Also stored on storage 190 can be database 180. As will be described in greater detail below, database 180 contains and/or maintains various data items and elements that are utilized throughout the various operations of signal enhancement system 100, including but not limited to digital signals 182 (e.g., images, audio, video, etc.), as will be described in greater detail herein. It should be noted that although database 180 is depicted as being configured locally to computing device 105, in certain implementations database 180 and/or various of the data elements stored therein can be located remotely (such as on a remote device or server—not shown) and connected to computing device 105 through network 160, in a manner known to those of ordinary skill in the art.

As referenced above, it should be noted that in certain implementations, such as the one depicted in FIG. 1, several of the computing devices 115, 125, 135 can be in periodic or ongoing communication with computing device 105 thorough a computer network such as the Internet 160. Though not shown, it should be understood that in certain other implementations, computing devices 115, 125, and/or 135 can be in periodic or ongoing direct communication with computing device 105, such as through communications interface 150.

Communication interface 150 is also operatively connected to circuit board 140. Communication interface 150 can be any interface that enables communication between the computing device 105 and external devices, machines and/or elements. In certain implementations, communication interface 150 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting computing device 105 to other computing devices and/or communication networks such as private networks and the Internet. Such connections can include a wired connection or a wireless connection (e.g. using the 802.11 standard) though it should be understood that communication interface 150 can be practically any interface that enables communication to/from the circuit board 140.

At various points during the operation of signal enhancement system 100, computing device 105 can communicate with one or more computing devices, such as those controlled and/or maintained by one or more individuals and/or entities, such as content provider 115, content manager 125, and/or content receiver 135, each of which will be described in greater detail herein. Such computing devices transmit and/or receive data to/from computing device 105, thereby initiating, maintaining, and/or enhancing the operation of the signal enhancement system 100, as will be described in greater detail below. It should be understood that the computing devices 115, 125, 135 can be in direct communication with computing device 105, indirect communication with computing device 105, and/or can be communicatively coordinated with computing device 105. While such computing devices can be practically any device capable of communication with computing device 105, in certain embodiments certain computing devices can be servers, while other computing devices can be user devices (e.g., personal computers, handheld/portable computers, smartphones, etc.), though it should be understood that practically any computing device that is capable of transmitting and/or receiving data to/from computing device 105 could be similarly substituted.

It should be noted that while FIG. 1 depicts signal enhancement system 100 with respect to computing devices 115, 125, and 135, it should be understood that any number of computing devices can interact with the signal enhancement system 100 in the manner described herein. It should be further understood that a substantial number of the operations described herein are initiated by and/or performed in relation to such computing devices. For example, as referenced above, such computing devices can execute applications and/or viewers which request and/or receive data from computing device 105, substantially in the manner described in detail herein.

In the description that follows, certain embodiments and/or arrangements are described with reference to acts and symbolic representations of operations that are performed by one or more devices, such as the signal enhancement system 100 of FIG. 1. As such, it will be understood that such acts and operations, which are at times referred to as being computer-executed or computer-implemented, include the manipulation by processor 110 of electrical signals representing data in a structured form. This manipulation transforms the data and/or maintains them at locations in the memory system of the computer (such as memory 120 and/or storage 190), which reconfigures and/or otherwise alters the operation of the system in a manner understood by those skilled in the art. The data structures in which data are maintained are physical locations of the memory that have particular properties defined by the format of the data. However, while an embodiment is being described in the foregoing context, it is not meant to provide architectural limitations to the manner in which different embodiments can be implemented. The different illustrative embodiments can be implemented in a system including components in addition to or in place of those illustrated for the signal enhancement system 100. Other components shown in FIG. 1 can be varied from the illustrative examples shown. The different embodiments can be implemented using any hardware device or system capable of running program code. In another illustrative example, signal enhancement system 100 can take the form of a hardware unit that has circuits that are manufactured or configured for a particular use. This type of hardware can perform operations without needing program code to be loaded into a memory from a computer readable storage device to be configured to perform the operations.

For example, computing device 105 can take the form of a circuit system, an application specific integrated circuit (ASIC), a programmable logic device, or some other suitable type of hardware configured to perform a number of operations. With a programmable logic device, the device is configured to perform the number of operations. The device can be reconfigured at a later time or can be permanently configured to perform the number of operations. Examples of programmable logic devices include, for example, a programmable logic array, programmable array logic, a field programmable logic array, a field programmable gate array, and other suitable hardware devices. With this type of implementation, software modules 130 can be omitted because the processes for the different embodiments are implemented in a hardware unit.

In still another illustrative example, computing device 105 can be implemented using a combination of processors found in computers and hardware units. Processor 110 can have a number of hardware units and a number of processors that are configured to execute software modules 130. In this example, some of the processors can be implemented in the number of hardware units, while other processors can be implemented in the number of processors.

In another example, a bus system can be implemented and can be comprised of one or more buses, such as a system bus or an input/output bus. Of course, the bus system can be implemented using any suitable type of architecture that provides for a transfer of data between different components or devices attached to the bus system. Additionally, communications interface 150 can include one or more devices used to transmit and receive data, such as a modem or a network adapter.

Embodiments and/or arrangements can be described in a general context of computer-executable instructions, such as program modules, being executed by a computer. Generally, program modules include routines, programs, objects, components, data structures, etc., that perform particular tasks or implement particular abstract data types.

It should be further understood that while the various computing devices and machines referenced herein, including but not limited to computing device 105, computing devices 115, 125, and 135 are referred to herein as individual/single devices and/or machines, in certain implementations the referenced devices and machines, and their associated and/or accompanying operations, features, and/or functionalities can be arranged or otherwise employed across any number of devices and/or machines, such as over a network connection, as is known to those of skill in the art.

It should also be noted that, although not shown in FIG. 1, various additional components can be incorporated within and/or employed in conjunction with computing device 105. For example, computing device 105 can include an embedded and/or peripheral image capture device such as a camera and/or an embedded and/or peripheral audio capture device such as a microphone.

The operation of the signal enhancement system 100 and the various elements and components described above will be further appreciated with reference to the description and illustrative figures provided herein.

Described herein are various routines, processes, and/or methods that serve to illustrate various broad aspects of a method for quality enhancement of low quality (‘LQ’) digital signals, such as those that originated from a high quality (‘HQ’) signal that went through one or more distortion processes in accordance with at least one embodiment disclosed herein. Some of the distortion processes can be modeled as series of linear operators with a random process such as, sampling (which is both linear and lossy), blur, noise, etc., while in other cases some of the distortion process, such as lossy compression, cannot be modeled as such. It should be appreciated that several of the logical operations described herein are implemented (1) as a sequence of computer implemented acts or program modules running on signal enhancement system 100 and/or (2) as interconnected machine logic circuits or circuit modules within the signal enhancement system 100. The implementation is a matter of choice dependent on the requirements of the device (e.g., size, energy, consumption, performance, etc.). Accordingly, the logical operations described herein are referred to variously as operations, steps, structural devices, acts, or modules. As referenced above, several of these operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

Consider the following exemplary working model:

Assume that there exists some high quality (HQ) vector f of size N_{f}×1, a set of known low quality (LQ) observations {ĝₙ}ₙ₌₁^{N} of sizes N_{g}_{ₙ}×1, a set of known linear operators {Lₙ}ₙ₌₁^{N}, and a set of known non-linear (typically lossy) operators {Qₙ}ₙ₌₁^{N} with N≧1 (we can always concatenate the observations and operators so that N=1) so that

ĝₙ=Qₙ(Lₙf+vₙ) subject to: fεG₀ (Eq.1)

With vₙ being a modeling error of size N_{g}_{ₙ}×1, and G₀ being the convex hull of all feasible values of f.

It should be noted that, in certain implementations, the non-linear operators Qₙ can themselves be a combination of linear and non-linear operators (and as such can be utilized in solving the problem). Additionally, in certain implementations, by finding the best linear operator for a given problem, and correctly modeling the error, improved results can be achieved (thereby enhancing the referenced LQ signals, for example).

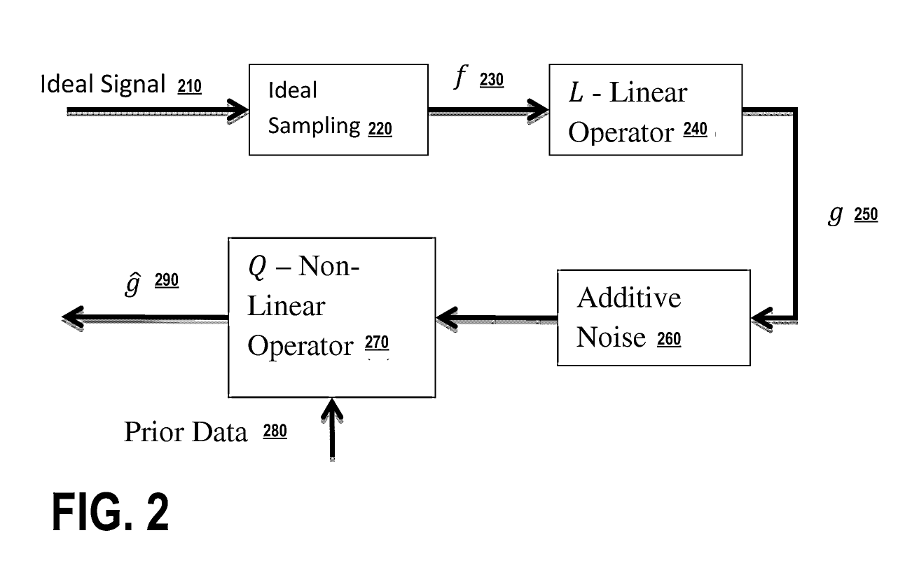

The technologies described herein can be implemented via a model which is illustrated in FIG. 2. As shown in FIG. 2, the model begins with an ideal signal 210. At block 220, it can be assumed that the ideal signal 210 was ideally sampled to yield a HQ digital signal f 230. It should be understood that it is this digital signal f 230 which the techniques described herein enable reconstruction/determination of.

At block 240, the HQ signal 230 can be processed through/in relation to a linear system/filter, and, in doing so, an intermediate LQ signal g 250 is yielded. It should be understood that LQ signal g 250 is the slack variable which can be utilized to solve the problem, as described herein.

At block 260, additive noise, which can have a statistical nature, can be added to model, for example the sensor (and/or any other such) inaccuracy, distortion, etc. Then, at block 270, the LQ signal can be processed, such as through/in relation to a non-linear operator—Q, which can correspond, for example, to encoding and/or quantization, and which can change its functionality based on some prior data 280 (for example, MPEG compression which depends on the values of previously compressed frames). This operation is referenced herein as encoding, though it should be understood that any other non-linear operator can be similarly implemented. The result of the referenced/described operations is a filtered, noisy and encoded signal—ĝ 290.

Repeating this process N≧1 times yields the problem formulated in Eq.1. It should be noted that, in certain implementations, the error vector vₙ can account for all the modeling errors, including the encoded additive noise.

The technologies described herein enable the modeling (when possible) of the referenced non-linear process which the HQ signal underwent, as a series of linear operators that can be generated from the LQ signal with some constraints. Upon computing such a formulation, the problem (the problem formulated in Eq.1) can be solved, for example, using mathematical optimization methods. In doing so, the HQ signal can thereby be reconstructed.

In certain implementations, the non-linear process (e.g., at block 270 as shown in FIG. 2) can be modeled by introducing one or more slack variables, e.g., {gₙ}ₙ₌₁^{N}, where gₙ=Lₙf+vₙ is a LQ signal (e.g., signal 250 as shown in FIG. 2), before compression. Next, assume that given a linear approximation of the quantization process Qₙ* (e.g., at block 270 as shown in FIG. 2), the approximation error can be bound,

Qₙ(gₙ)−Qₙ*gₙεGₙ

where Gₙ is some closed convex set (in the vector space in which gₙ lies) (it should be noted that alternatively we can bound (Qₙ*)⁻¹Qₙ(gₙ)−gₙε(Qₙ*)⁻¹Gₙ and/or apply any other invertible linear operator onto both sides).

Accordingly, it can be appreciated that Eq.1 can be reformulated as follows:

gₙ=Lₙf+vₙ, subject to: fεG₀,(Qₙ*gₙ−ĝₙ)εGₙ

It can be further appreciated that this set of equations leads to the following convex programming problem:

$${argmin}_{f , {\{ {g}_{n} \}}_{n = 1}^{N}} \{ {\sum }_{n = 1}^{N} [ {α}_{n} {D}_{n} ( {Q}_{n}^{*} {g}_{n} - {Q}_{n}^{*} {L}_{n} f ) ] + β F ( f , {g}_{1} , … , {g}_{n} ) \} \\ Subject to \\ ( {Q}_{n}^{*} {g}_{n} - {\hat{g}}_{n} ) ∈ {G}_{n} , f ∈ {G}_{0} , for n = 1 , … , N \qquad ( Eq . 2 )$$

Where Dₙ is some convex distance function (a distance function D(•) achieves its global minimum at x=“0”. Typically D (“0”)=0. Here “0” denotes the zeros-vector), F is some convex function which considers/accounts for prior knowledge of f and β, {aₙ}ₙ₌₁^{N} are some (positive) scalars, which weigh the importance of each observation and prior knowledge.

It should be noted that the referenced convex programming formulation is a function of not only the desired HQ signal/image f but also the new intermediate/slack variables {gₙ}ₙ₌₁^{N}. It should also be noted that the prior knowledge function can be extended to also consider/account for prior knowledge that may be available regarding the slack variables.

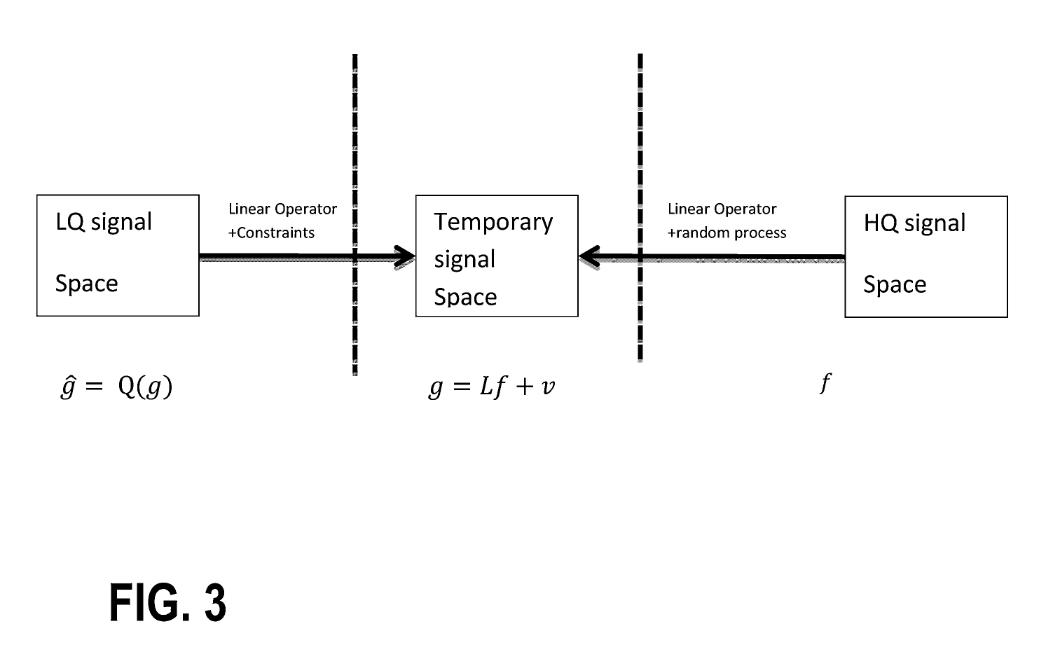

The technologies described herein can be further appreciated with reference to FIG. 3 which depicts a schematic diagram of various aspects of the present disclosure. As can be appreciated with reference to FIG. 3, instead and/or in lieu of modeling the encoding (g→ĝ) process as linear and adding constraints, the inverse process (ĝ→g) can be modeled as linear with constraints. Note that g is not really a variable in the original problem formulation and its addition can effectively enable the solving of an actual linear problem, while forcing the solution to comply with non-linearity which was introduced through constraints.

It should be appreciated that (Eq.2) is a convex programming (CP) problem. It can be further appreciated that there are any number of methods of solving CP problems (since the target function to be minimized is the sum of strictly convex functions, and the constraint is the intersection of closed convex sets, the problem is convex), as are known to those of ordinary skill in the art. Accordingly, it should be understood that, depending on the actual formulation of the problem for a specific setting, the formulation provided above can be simplified and/or solved in various ways (such as those that are faster, utilize less memory, are more accurate, etc.). Nonetheless, it can be appreciated that, in most cases, a convex problem can be solved (given enough time, memory and computational resources) with sufficient accuracy for all practical purposes.

To illustrate how the referenced problem can be solved, let us reformulate it for simplicity. Denote x=(f′, g′₁, . . . , g′_{N})′, so that x is a single vector containing a column stack of all the variables in the problem. Also define

T(x)=T(f,g₁, . . . ,g_{N})=Σₙ₌₁^{N}[aₙDₙ(Qₙ*gₙ−Qₙ*Lₙf)]+βF(f,g₁, . . . ,gₙ)

and G as the equivalent constraint set for x, then we can rewrite the problem as:

$${argmin}_{x} \{ T ( x ) \} subject to \text{:} x ∈ G$$

With both T, G being convex. An example technique for solving this problem is as follows:

1. Provide an initial attempt/guess for solution x; x₀

2. Initialize counter n=1, choose stop conditions ε₁, ε₂, Nᵢₜₑᵣ

3. While the stop condition(s) is/are not met, iterate:
a. Compute descending direction (e.g., by computing the numerical or analytical (if possible) gradient) vₙ (unit vector of the same size at x)
b. Find a step size in the descending direction tₙ (e.g., by performing a line search)
c. Update x=xₙ₋₁+tₙvₙ and update n=n+1
d. If tₙ<ε₁ and ∥T(xₙ)−T(xₙ₋₁)∥<ε₂ stop
e. If n>Nᵢₜₑᵣ stop

The utility and advantages of the referenced formulation can be appreciated by way of illustration with respect to a problem in the field of video enhancement, such as super-resolution (SR) from MPEG-compressed video. Stated differently, this is the problem of trying to re-create one (or more) HQ image(s) from a LQ compressed video sequence—for example a poorly seen license plate in a surveillance video.

In this case/example:
f is a desired HQ (e.g., high resolution) video frame.
N≧1 is the number of relevant frames.
ĝₙ are the decompressed (after compression) LQ frames.
The linear operators Lₙ are the product of warp (relative motion), optical blur and decimation (sub-sampling).
Qₙ is the MPEG compression and decompression operator (so the result is the compressed image in the spatial domain).
Qₙ* in this case is the identity operator.
gₙ—are the LQ images before compression.
If the error, vₙ, is assumed to be a white Gaussian noise and the problem is solved using maximum-aposteriori (MAP) formulation then Dₙ becomes the (L²) square-norm function.
The constraint on f, G₀, becomes the possible pixel range (for example 0-255 for each pixel).
The constraints on each of the observations, Gₙ, becomes the set of possible sources which yield ĝₙ (depending on the corresponding quantization matrix).
F can be practically any prior—for example a prior on natural images, or a prior on human faces etc. For example, a bilateral prior with β≈0.1 can be utilized.
aₙ is a function of the estimated noise level in each image (the higher the noise, the lower the weight). In general, since this is a video stream,

$${α}_{n} \approx \frac{1}{N} .$$

To further simplify the problem, the following can be defined:
bₙ=Tgₙ where T is, for example, the block-DCT transform employed in the MPEG compression scheme.
gₙ^{mc}—the motion compensation guess for gₙ as computed by the MPEG encoder.
dₙ=T(gₙ−gₙ^{mc})—the motion compensation DCT domain error.
qₙ—a vector containing the quantization operation step size for the corresponding pixel in the DCT domain for the n-th frame.
\hat{d}ₙ=Qₙ(dₙ)—the quantized (or compressed) motion compensation DCT domain error for the n-th image.
\hat{b}ₙ=Tĝₙ—the DCT domain decompressed LQ n-th video frame.

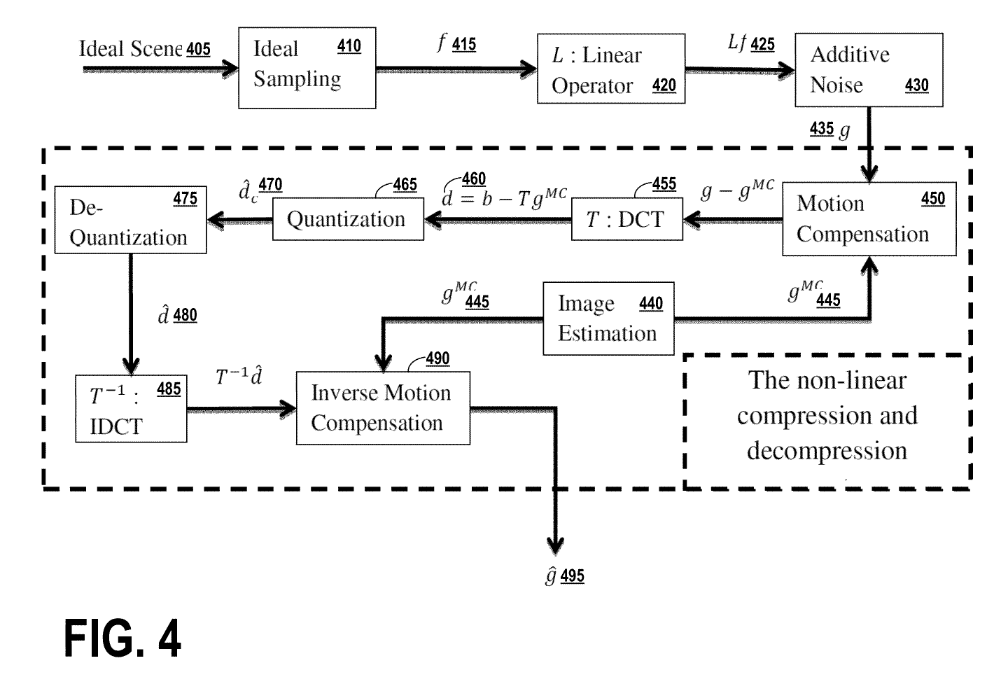

The described exemplary process can be further appreciated with referenced to FIG. 4. As depicted in FIG. 4, ideal scene 405 can correspond to the real world (e.g., as it was at the moment of capturing), and which can go through ideal sampling 410 to produce f 415 which, in certain implementations, can correspond to an unknown that can be used to formulate the problem.

As shown in FIG. 4, g 435 corresponds to an unknown LQ signal. f is modeled as going through a cascade of linear operators 420, for example warp followed by optical and motion blur followed by ideal resampling (subsampling). Additionally, some statistical noise 430 can also be added to the resulting signal (e.g., the signal Lf 425 as modeled through the various linear operators) to model, for example, the capturing CCD imperfection. The result is g 435.

At block 440, motion estimation can be performed, such as based on past images (e.g., compressed images) (if any exist), and/or using one or more other techniques, such are known to those of ordinary skill in the art. In doing so, the current image g can be estimated, yielding g^{MC} 445.

At block 450, the referenced motion can be compensated for by subtracting the estimated image g^{MC}445 from the actual signal g 435—and (at block 455) transformed to the DCT domain using yet another linear operator T (which can also be unitary), yielding a DCT domain estimation error d 460. At block 465, the referenced error d 460 can be quantized and saved (e.g., as \hat{d}_{c} 470).

At block 475, the referenced saved data (e.g., \hat{d}_{c} 470) can be de-quantized, yielding \hat{d} 480. At block 485, \hat{d} 480 can be multiplied by the inverse DCT, the result of which can be combined (at block 490) with the previously subtracted guess g^{MC} 445, resulting in ĝ 495.

It should be further appreciated that Q*g−ĝ=g−ĝεG can be bound. To do so we note the following:

$$\vert b - \hat{b} \vert = \vert T ( g - \hat{g} ) \vert = \vert T ( ( g - {g}^{MC} ) - ( \hat{g} - {g}^{MC} ) ) \vert = \vert d - \hat{d} \vert < \frac{q}{2}$$

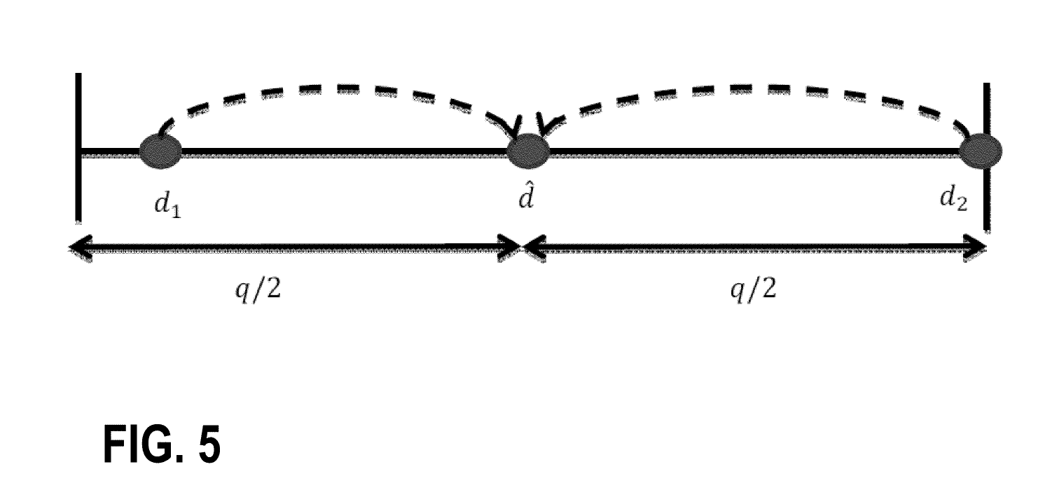

Now we consider that that the difference between d and \hat{d} is only quantization and de-quantization (e.g., blocks 465 and 475 as shown in FIG. 4). As such, it can be further appreciated that, as illustrated in FIG. 5, the maximum distance between each element and its compressed version is half the size of the quantization step. Accordingly, any entry within q/2 of the interval center, are quantized to the same value \hat{d}. As such, instead of bounding g−ĝ we can equivalently bound b−\hat{b}:

$$\vert b - \hat{b} \vert = \vert d - \hat{d} \vert < \frac{q}{2}$$

Where q is the quantization vector. Notice that this is an interval constraint, and can be handled by most convex solvers. Further extending this to n observations, the nominal problem can be formulated as follows:

$${argmin}_{f , {\{ {g}_{n} \}}_{n = 1}^{N}} \{ {\sum }_{n = 1}^{N} {α}_{n} {‖ {g}_{n} - {L}_{n} f ‖}^{2} - β F ( f ) \} s . t . \{ \vert T {g}_{n} - T {g}_{n}^{MC} - {\hat{d}}_{n} \vert \leq 0.5 {q}_{n} , 0 \leq f \leq 255 \}$$

Further noting that T is unitary; the problem can be further reformulated as:

$${argmin}_{f , {\{ {b}_{n} \}}_{n = 1}^{N}} \{ {\sum }_{n = 1}^{N} {α}_{n} {‖ {b}_{n} - T {L}_{n} f ‖}^{2} - β F ( f ) \} s . t . \{ \vert {b}_{n } - {\hat{b}}_{n} \vert \leq 0.5 {q}_{n} , 0 \leq f \leq 255 \}$$

If the prior chosen for f is convex, this problem-formulation can be solved using convex optimization tools, as are known to those of ordinary skill in the art.

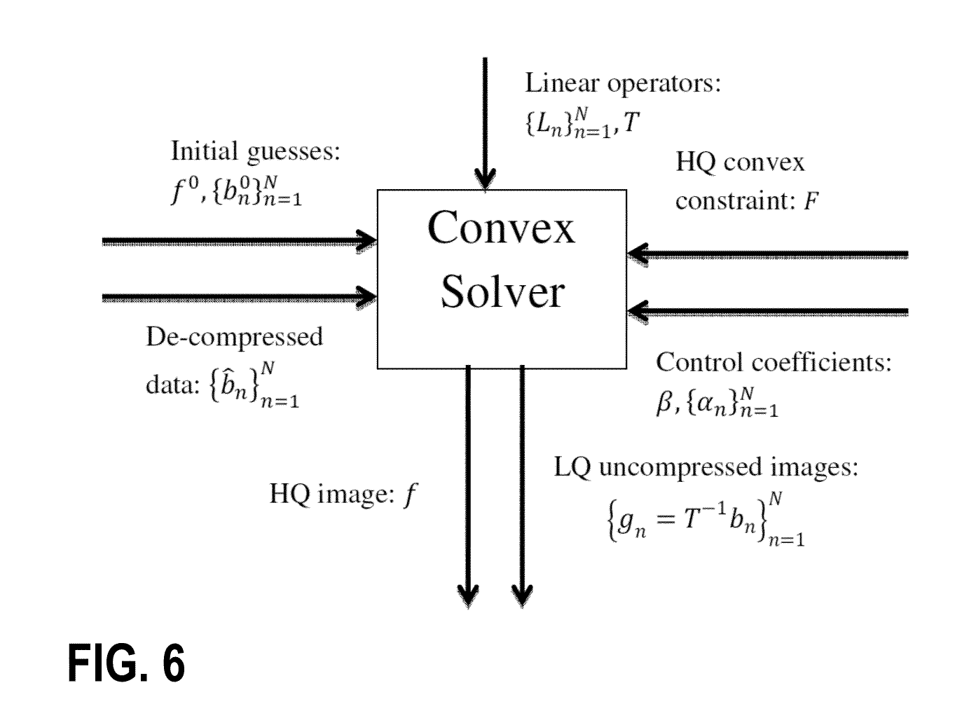

As illustrated in FIG. 6, in certain implementations, any number of the following can improve/further enable the solving of such a problem:
The DCT domain de-compressed images {\hat{b}ₙ=Tĝₙ}ₙ₌₁^{N}
The quantization table—{qₙ}ₙ₌₁^{N}.
The linear acquisition model {Lₙ}ₙ₌₁^{N}, T
Practically any reasonable and convex constraint of the HQ data (for example requiring smoothness by applying a derivate operator onto f; F(f)=∥∇f∥)
Some reasonable constants for β, {aₙ}ₙ₌₁^{N} (for example

$${a}_{n} = \frac{1}{N} ,$$

β=0.1).
Some convex solver which can solve the resulting equation.
Any initial guess for f, {bₙ}ₙ₌₁^{N}

It should be noted that the resulting formulation can be independent from the motion estimation used by the compressor, as it only requires, in certain implementations, the knowledge of the de-compressed images, the DCT transform (or any other transform used for compression in other schemes) and/or the quantization step/table (which can be, for example, extracted from the coded video and/or estimated from de-compressed sequence). It should also be noted that the described techniques can easily be extended for more complex compressors such as H.264 or MPEG4.

At this juncture, it should be noted that although much of the foregoing description has been directed to systems and methods for digital signal (such as image) enhancement, the systems and methods disclosed herein can be similarly deployed and/or implemented in scenarios, situations, and settings far beyond the illustrated scenarios. It can be readily appreciated that signal enhancement system 100 can be effectively employed in practically any scenario where various signal enhancement approaches can be useful. It should be further understood that any such implementation and/or deployment is within the scope of the systems and methods described herein.

It is to be understood that like numerals in the drawings represent like elements through the several figures, and that not all components and/or steps described and illustrated with reference to the figures are required for all embodiments or arrangements. It should also be understood that the embodiments, implementations, and/or arrangements of the systems and methods disclosed herein can be incorporated as a software algorithm, application, program, module, or code residing in hardware, firmware and/or on a computer useable medium (including software modules and browser plug-ins) that can be executed in a processor of a computer system or a computing device to configure the processor and/or other elements to perform the functions and/or operations described herein. It should be appreciated that according to at least one embodiment, one or more computer programs, modules, and/or applications that when executed perform methods of the present disclosure need not reside on a single computer or processor, but can be distributed in a modular fashion amongst a number of different computers or processors to implement various aspects of the systems and methods disclosed herein.

Thus, illustrative embodiments and arrangements of the present systems and methods provide a computer implemented method, computer system, and computer program product for enhancing digital signals. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present disclosure, which is set forth in the following claims.

What is claimed is:

1. A method comprising:
receiving a digital signal that has undergone a non-linear distortion;
reformulating the non-linear distortion as one or more linear operators that yield a statistical connection between a first signal and a second signal and one or more convex constraints on at least one of the first signal or the second signal;
formulating a convex minimization problem in view of the first signal, the second signal, and the one or more convex constraints; and
processing the digital signal with a processor to solve the convex minimization problem, thereby generating an enhanced digital signal.

2. The method of claim 1, further comprising estimating one or more parameters of the non-linear distortion based on the digital signal.

3. The method of claim 2, wherein reformulating the non-linear distortion comprises reformulating the non-linear distortion in view of the one or more parameters.

4. The method of claim 1, wherein reformulating the non-linear distortion comprises processing the digital signal to generate a model comprising one or more linear operators and statistical noise.

5. The method of claim 1, wherein reformulating the non-linear distortion comprises introducing one or more slack variables.

6. The method of claim 5, wherein reformulating the non-linear distortion comprises modeling a non-linearity of the non-linear distortion by introducing at least one of the one or more slack variables between a linear part of an acquisition model and a non-linear part of the acquisition model.

7. The method of claim 5, wherein the one or more slack variables comprise the second signal.

8. The method of claim 5, wherein at least one of the one or more slack variables comprise a signal generated based on a processing of a high quality signal through a linear system.

9. The method of claim 5, wherein reformulating the non-linear distortion further comprises applying at least one of the one or more convex constraints on at least one of the one or more slack variables.

10. The method of claim 1, wherein the non-linear distortion comprises compression.

11. The method of claim 1, wherein the non-linear distortion comprises a combination of one or more linear operators and one or more non-linear operators.

12. The method of claim 1, wherein the digital signal comprises at least one of video, audio, or an image.

13. The method of claim 1, wherein the enhanced digital signal comprises the first signal.

14. A system comprising:
a memory; and
a processor, coupled to the memory, to:
receive a digital signal that has undergone a lossy distortion;
reformulate the lossy distortion as one or more linear operators that yield a statistical connection between a first signal and a second signal and one or more convex constraints on at least one of the first signal or the second signal;
formulate a convex minimization problem in view of the first signal, the second signal, and the one or more convex constraints; and
process the digital signal to solve the convex minimization problem, thereby generating an enhanced digital signal.

15. The system of claim 14, wherein the processor is further to estimate one or more parameters of the lossy distortion based on the digital signal and wherein to reformulate the lossy distortion is to reformulate the lossy distortion in view of the one or more parameters.

16. The system of claim 14, wherein to reformulate the lossy distortion is to process the digital signal to generate a model comprising one or more linear operators and statistical noise.

17. The system of claim 14, wherein to reformulate the lossy distortion is to introduce one or more slack variables, wherein at least one of the one or more slack variables comprise a signal generated based on a processing of a high quality signal through a linear system.

18. The system of claim 17, wherein to reformulate the lossy distortion is to model a non-linearity of the lossy distortion by introducing at least one of the one or more slack variables between a linear part of an acquisition model and a non-linear part of the acquisition model.

19. The system of claim 17, wherein to reformulate the lossy distortion is further to apply at least one of the one or more convex constraints on at least one of the one or more slack variables.

20. A non-transitory computer readable medium having instructions stored thereon that, when executed by a processor, cause the processor to perform operations comprising:
receiving a digital signal that has undergone a non-linear distortion, the digital signal comprising a compressed video, the compressed video comprising one or more images, and the non-linear distortion comprising one or more of warp, blur, sampling, or noise, followed by a lossy compression;
reformulating the non-linear distortion as one or more linear operators that yield a statistical connection between a first signal and a second signal and one or more convex constraints on at least one of the first signal or the second signal, the first signal comprising a high quality image and the second signal comprising one or more slack variables that correspond to the one or more images after the one or more of warp, blur, sampling, or noise has been applied thereto;
formulating a convex minimization problem in view of the first signal, the second signal, and the one or more convex constraints, the one or more convex constraints comprising one or more constraints on a distance between the one or more slack variables and the digital signal; and
processing the digital signal to solve the convex minimization problem, thereby generating an enhanced digital signal.
